(19) United States
(12) Patent Application Publication
(10) Pub. No.: US 2026/0364871 A1
(43) Pub. Date: Nov. 19, 2026

(54) STRETCHING APPARATUS

(71) Applicant: IMOTO MACHINERY CO., LTD, Kyoto-shi, Kyoto (JP)

(72) Inventor: Toshiyuki IMOTO, Kyoto-shi (JP)

(73) Assignee: IMOTO MACHINERY CO., LTD, Kyoto-shi, Kyoto (JP)

(21) Appl. No.: 19/477,294

(22) PCT Filed: Dec. 16, 2024
(86) PCT No.: PCT/JP2024/044436

§ 371 Date: Oct. 21, 2025

(30) Foreign Application Priority Data
Dec. 21, 2023 (JP) 2023-216316
Oct. 2, 2024 (JP) 2024-173159

(51) Int. Cl. B29C 55/16; B29K 105/00

(52) U.S. Cl. CPC B29C 55/165; B29K 2105/256

(57) ABSTRACT

In a biaxial stretching apparatus, each of stretching mechanisms provided respectively on four sides of a sheet to be processed includes: a slider box including a rail provided in parallel to a corresponding side of the stretching mechanism and the two sliders configured to slide on the rail; chucks respectively provided in the two sliders configured to grip the corresponding side of the sheet to be processed; and a drive mechanism configured to pull the slider box in a direction perpendicular to the corresponding side. Since the rail, which is a component for adjusting the interval between the chucks, is provided in parallel to the corresponding side of the sheet to be processed, the space occupied by the apparatus in the direction perpendicular to the corresponding side can be suppressed, whereby the entire apparatus can be downsized.

### TECHNICAL FIELD

The present invention relates to a stretching apparatus such as a biaxial stretching apparatus configured to stretch a sheet to be processed made of a thermoplastic resin or the like in two directions.

### BACKGROUND ART

A biaxial stretching apparatus is used when a sheet to be processed, which is an original sheet to be processed, is processed by being stretched so as to produce a sheet-shaped product thinner than the original sheet to be processed. For example, in a biaxial stretching apparatus described in Patent Literature 1, a plurality of arms is attached to each side of a square sheet to be processed by a clip (chuck), and the plurality of arms on each side is connected to each other by a pantograph.

When the arms of the four sides are moved outward in this state, the sheet to be processed is stretched in two directions. As the sheet to be processed is stretched, the interval between the plurality of arms of each side is forced to be widened, where the pantograph provided between the arms of each side absorbs the widening between the arms of the side and adjusts the widening to be uniform.

### CITATION LIST

### Patent Literature

Patent Literature 1: JP 2005-199617 A

Patent Literature 2: JP H01-088660 U

### SUMMARY OF INVENTION

### Technical Problem

In the biaxial stretching apparatus described in Patent Literature 1, the pantograph is longest in the direction perpendicular to each side of the sheet to be processed in an initial state (a state in which the sheet to be processed is not yet stretched), and is longest in the direction parallel to each side when the sheet to be processed is maximally stretched. The size of the pantograph is determined by the length of each side of the sheet to be processed when it is maximally stretched. Therefore, as the stretch ratio of the sheet to be processed is increased, the length of the pantograph in the direction perpendicular to each side in the initial state increases, and as a result, the size of the entire apparatus increases.

An object of the present invention is to provide a stretching apparatus such as a biaxial stretching apparatus that can be downsized.

### Solution to Problem

In a biaxial stretching apparatus according to a first mode of the present invention made to solve the above problems, each of stretching mechanisms provided respectively on four sides of a sheet to be processed includes:
a) a slider box including a rail provided in parallel to a corresponding side of the stretching mechanism and two sliders configured to slide on the rail;
b) chucks respectively provided in the two sliders configured to grip the corresponding side of the sheet to be processed; and
c) a drive mechanism configured to pull the slider box in a direction perpendicular to the corresponding side.

In the biaxial stretching apparatus according to the present invention, the stretching mechanism of each side (corresponding side) includes two sliders, and a chuck provided in each slider grips the corresponding side. By pulling the slider boxes of the stretching mechanisms of the side and the side (opposing side) opposing the said side in opposite directions to each other by the drive mechanisms, the sheet to be processed is pulled in a direction connecting the sides (direction perpendicular to the sides).

At the same time, the sheet to be processed is similarly pulled by the stretching mechanisms on two sides adjacent to the sides. Then, when the two sliders slide on the rails, the interval between the two chucks respectively provided in the two sliders and gripping the sheet to be processed on the corresponding side and the opposing side increases. In the biaxial stretching apparatus according to the present invention, the widening of the interval between the two chucks is absorbed by the respective sliders sliding in the slider box.

According to the biaxial stretching apparatus according to the present invention, since the rail, which is a component for adjusting the interval between the chucks, is provided in parallel to the corresponding side of the sheet to be processed, the space occupied by the apparatus in the direction perpendicular to the corresponding side can be suppressed, whereby the entire apparatus can be downsized.

The biaxial stretching apparatus according to the present invention may further include:
d) racks having the same pitch respectively fixed to the two sliders;
e) pinions having the same number of teeth which respectively mesh with the two racks; and
f) a synchronization mechanism configured to synchronously rotate the two pinions in opposite directions to each other.

According to the biaxial stretching apparatus of this mode, since the two sliders slide in the opposite directions in synchronization with each other, it is possible to prevent the problem that any one of the sliders is caught and does not move.

The biaxial stretching apparatus according to the present invention may further include
g) a synchronous expansion mechanism configured to rotate two pinions of the present stretching mechanism in synchronization with movement of the drive mechanisms of the stretching mechanisms corresponding to two adjacent sides of the sheet to be processed.

According to the biaxial stretching apparatus of this mode, since the two sliders are driven to slide in opposite directions to each other so as to be synchronized with the driving speed of the two adjacent sides, that is, the pulling speed of the two adjacent sides, the pulling speeds of the four sides are synchronized, and the smooth biaxial stretching treatment of the sheet to be processed can be performed.

The biaxial stretching apparatus according to the present invention allows, in addition to the two rack-attached sliders, rails for sliding two additional rack-attached sliders to be provided in the slider box, and an additional chuck for gripping the corresponding side of the sheet to be processed and an additional pinion to be provided together respectively in the two additional rack-attached sliders, and the additional racks and the additional pinions of the two additional rack-attached sliders to be set so as to move in opposite directions to each other at a speed corresponding to gripping positions of the two chucks and the two additional chucks on the corresponding side.

According to the biaxial stretching apparatus of this mode, each side of the sheet to be processed is pulled by four chucks, and the interval between the four chucks can be extended in synchronization according to the pulling speed of the two adjacent sides and according to the position of each chuck, so that a smoother biaxial stretching treatment can be performed.

The drive mechanism used in the biaxial stretching apparatus according to the present invention can also be suitably used in stretching apparatuses other than biaxial stretching apparatus. A stretching apparatus according to a second mode of the present invention includes:
two rod-shaped gripping members configured to grip two opposing sides of a rectangular sheet to be processed along the respective sides;
two first gripping member holding parts configured to rotatably hold respective one ends of the two gripping members;
two second gripping member holding parts configured to rotatably hold the respective other ends of the two gripping members; and
a drive mechanism configured to pull the two first gripping member holding parts and the two second gripping member holding parts at different speeds from each other in a direction perpendicular to the two sides.

In the stretching apparatus of the second mode, two opposing sides of a rectangular sheet to be processed before stretching are gripped by two rod-shaped gripping members along the respective sides, and then the two first gripping member holding parts and the two second gripping member holding parts are pulled at different speeds from each other in a direction perpendicular to the two sides by a drive mechanism. Consequently, while the two gripping members rotate with respect to the first gripping member holding part and the second gripping member holding part holding the two gripping members, one end and the other end are separated from each other at different speeds. Consequently, the sheet to be processed is non-uniformly stretched in a direction perpendicular to the two sides such that a stretching ratio (a ratio of the length after stretching to the length before stretching) varies depending on a position between the one end and the other end.

The state in which a rectangular sheet to be processed is unevenly stretched such that the stretching ratio varies depending on the position corresponds to a transient state that occurs, for example, in a mass production apparatus for sheets, as described in Patent Literature 2, in which two opposing sides of the sheet to be processed are held by clips configured to move along two rails provided so that the interval gradually increases in some sections, thereby stretching the sheet to be processed. The stretching apparatus of the second mode can be suitably used as a testing machine for examining a state of a polymer or the like in a sheet to be processed in a transient state in such a mass production apparatus.

In the stretching apparatus according to the second mode, the speed at which the drive mechanism pulls the two first gripping member holding parts may be zero. In this case, the two first gripping member holding parts may be fixed directly or via another member.

The stretching apparatus of the second mode can be configured by, as an option of the stretching apparatus of the first mode, attaching second gripping member holding parts to two opposing slider boxes of the four slider boxes. In this case, the remaining two slider boxes, the two drive mechanisms for pulling them, and the chucks provided in all the slider boxes are not used. Alternatively, the stretching apparatus of the second mode may be an apparatus different from the stretching apparatus of the first mode.

### Advantageous Effects of Invention

According to the present invention, a stretching apparatus such as a biaxial stretching apparatus can be downsized.

### BRIEF DESCRIPTION OF DRAWINGS

FIG. 1 A schematic top view illustrating an embodiment (first embodiment) of a biaxial stretching apparatus according to a first mode of the present invention.

FIG. 2 A perspective view illustrating a biaxial stretching apparatus of the first embodiment.

FIG. 3 A top view illustrating a slider box included in the biaxial stretching apparatus of the first embodiment.

FIG. 4 A bottom view of the biaxial stretching apparatus of the first embodiment, illustrating a state in which plates of upper and lower surfaces of a slider box are removed.

FIG. 5 A top view of the biaxial stretching apparatus of the first embodiment, illustrating a state in which the plates of the upper and lower surfaces of the slider box and a 0th chuck are removed.

FIG. 6 A side view of the biaxial stretching apparatus of the first embodiment, illustrating a state in which a plate of a side surface of the slider box is removed.

FIG. 7 A top view illustrating an initial position of a chuck when the biaxial stretching apparatus of the first embodiment is used.

FIG. 8 A top view illustrating an example of a position of a chuck when the biaxial stretching apparatus of the first embodiment is in use.

FIG. 9 A top view illustrating a state in which a sheet to be processed is stretched by the biaxial stretching apparatus of the first embodiment and a position of a chuck at that time.

FIG. 10 A schematic top view illustrating a state of the entire apparatus excluding a control unit when a sheet to be processed is stretched by the biaxial stretching apparatus of the first embodiment.

FIG. 11 A schematic top view illustrating another method of using the biaxial stretching apparatus of the first embodiment.

FIG. 12 A schematic top view illustrating an embodiment (second embodiment) of a stretching apparatus according to a second mode of the present invention.

FIG. 13 A partially enlarged top view of a stretching apparatus of the second embodiment.

FIG. 14 A bottom view (a) illustrating a configuration of a gripping member included in the stretching apparatus of the second embodiment, and a bottom view (b) illustrating a state in which the gripping member is rotated about a rotation pin of a second gripping member holding part.

FIG. 15 A top view illustrating a state in which a sheet to be processed is stretched by the stretching apparatus of the second embodiment.

FIG. 16 A top view illustrating a slider box in a biaxial stretching apparatus of a modification of the first embodiment.

FIG. 17 A top view illustrating a slider box in a biaxial stretching apparatus of another modification of the first embodiment.

### DESCRIPTION OF EMBODIMENTS

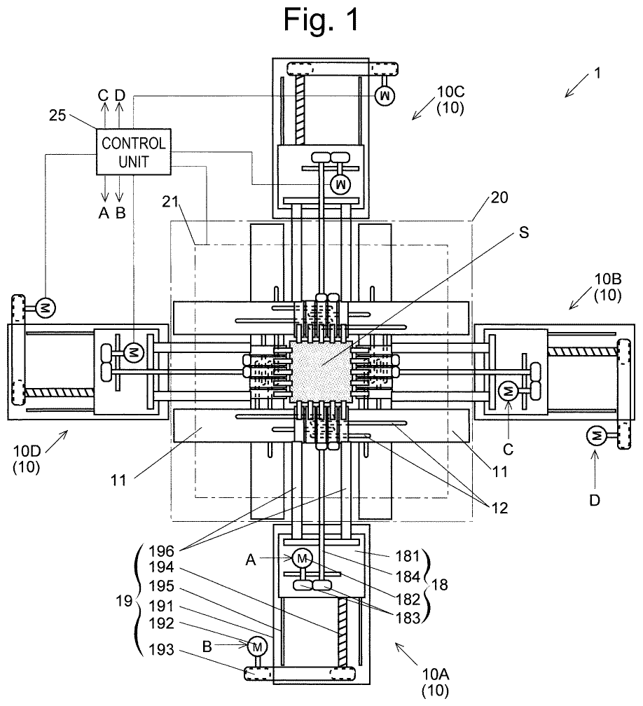

Embodiments of the stretching apparatus according to the present invention will be described with reference to FIGS. 1 to 17.

### (1) An Embodiment (First Embodiment) of a Biaxial Stretching Apparatus According to the First Mode of the Present Invention

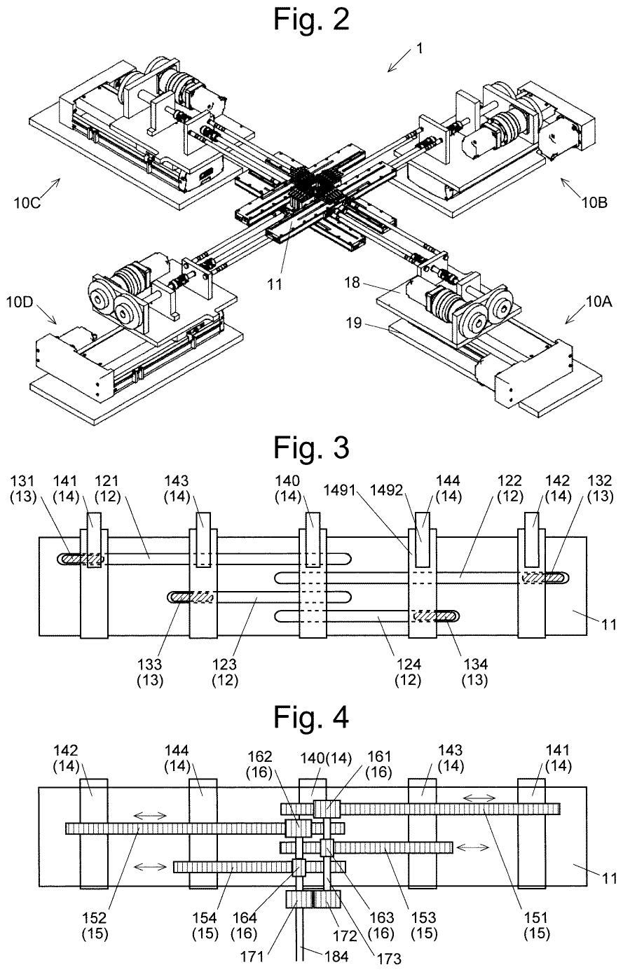

As illustrated in FIGS. 1 and 2, a biaxial stretching apparatus 1 of the first embodiment includes four stretching mechanisms 10 provided corresponding to the four sides of a sheet to be processed S. In FIGS. 1 and 2, these four stretching mechanisms are denoted by reference numerals 10A, 10B, 10C, and 10D in the counterclockwise order, but they all have the same configuration.

The stretching mechanism 10 has a slider box 11, a chuck 14, a drive mechanism 19, and the like.

The slider box 11 is a rectangular parallelepiped box, and has a shape in which a direction parallel to a side (hereinafter referred to as “corresponding side”) of the sheet to be processed S corresponding to the stretching mechanism 10 (this direction is referred to as “longitudinal direction”) is larger than the width direction and the height direction. As illustrated in FIG. 3, four rails 12 including slits parallel to the corresponding side are provided on the upper surface of the slider box 11. These four rails 12 are referred to as first rail 121, second rail 122, third rail 123, and fourth rail 124 in order from a side closer to the sheet to be processed S. In each rail 12, the first rail 121 and the second rail 122 have the same length, and the third rail 123 and the fourth rail 124 have the same length and are shorter than the first rail 121 and the second rail 122. The first rail 121 extends from a position close to one end in the longitudinal direction to a position closer to the other end than to the center in the direction. The second rail 122 extends from a position close to the other end to a position closer to the one end than to the center. The third rail 123 extends from a position closer to the one end than to an intermediate position between the one end and the center to a position closer to the other end than to the center. The fourth rail 124 extends from a position closer to the other end than to an intermediate position between the other end and the center to a position closer to the one end than to the center.

In the slider box 11, one slider 13 configured to slide along the rail 12 is accommodated for each rail 12 (FIG. 3). Hereinafter, the sliders 13 included in the first rail 121, the second rail 122, the third rail 123, and the fourth rail 124 are referred to as first slider 131, second slider 132, third slider 133, and fourth slider 134, respectively. Each slider 13 has a flat upper surface flush with the upper surface of the slider box 11, and a rack 15 described later is fixed to the lower surface.

One chuck 14 is fixed to the upper surface of each slider 13. The chuck 14 is disposed outside the slider box 11. The chucks 14 fixed to the first slider 131, the second slider 132, the third slider 133, and the fourth slider 134 are referred to as first chuck 141, second chuck 142, third chuck 143, and fourth chuck 144, respectively. Each chuck 14 has a base portion 1491 whose lower surface is fixed to each slider 13, and a gripping portion 1492 configured to grip the sheet to be processed S. A part of the base portion 1491 protrudes closer to the corresponding side of the sheet to be processed S than to the upper surface of the slider box 11, and the gripping portion 1492 is provided at the protruding portion. All of the first chuck 141 to the fourth chuck 144 move in the longitudinal direction of the slider box 11 as the first slider 131 to the fourth slider 134 slide along the first rail 121 to the fourth rail 124.

Apart from the first chuck 141 to the fourth chuck 144, a 0th chuck 140 is fixed to the center of the upper surface of the slider box 11 in the longitudinal direction outside the slider box. The 0th chuck 140 is not fixed with the slider 13 or the rack 15 to be described later, and does not move from the center in the longitudinal direction.

In each chuck 14, the first chuck 141, the third chuck 143, the 0th chuck 140, the fourth chuck 144, and the second chuck 142 are arranged in this order from one end in the longitudinal direction, and this arrangement order does not change even when each chuck 14 moves in the longitudinal direction.

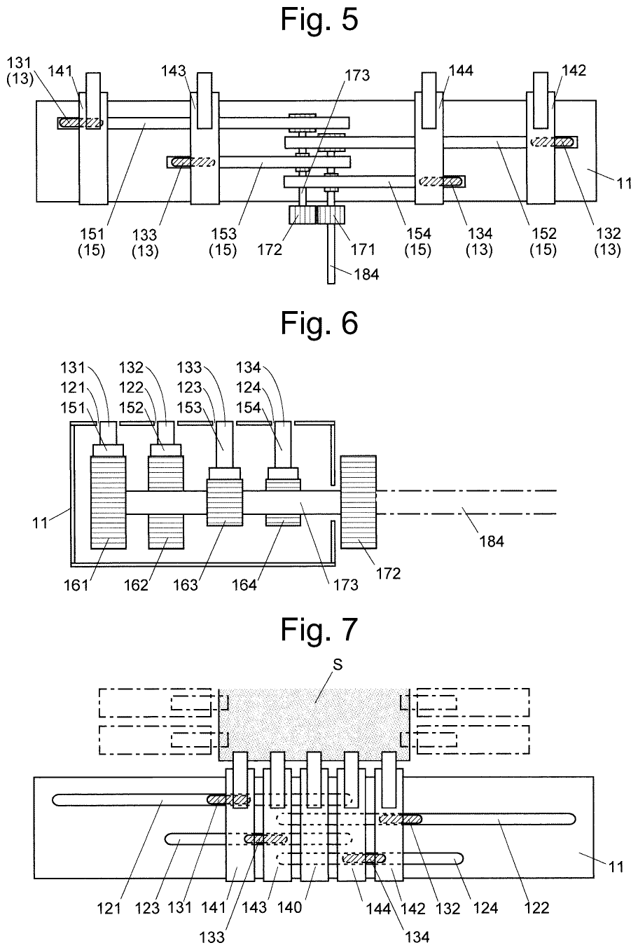

The rack 15 is provided on a lower surface (in the slider box 11) of each slider 13. Hereinafter, in order to contribute to understanding of the configuration of the rack 15, a pinion 16 to be described later, and the like, the description will be given with reference to FIG. 4 which is a bottom view and FIG. 5 which is a top view illustrating a state in which the plates of the upper and lower surfaces of the slider box 11 are removed. FIG. 5 illustrates a state in which the 0th chuck 140 is further removed. The racks 15 fixed to the first slider 131, the second slider 132, the third slider 133, and the fourth slider 134 are referred to as first rack 151, second rack 152, third rack 153, and fourth rack 154, respectively. Each rack 15 extends in the longitudinal direction of the slider box 11, has a gear formed on the lower surface (FIG. 4), and has a flat upper surface (FIG. 5). This flat upper surface is fixed to the lower surface of the slider 13. Each rack 15 is movable in the longitudinal direction. The pitch of the gear teeth of each rack 15 is the same.

In the slider box 11, a total of four pinions 16, one each meshing with each rack 15, are further provided. The pinions 16 provided corresponding to the first rack 151, the second rack 152, the third rack 153, and the fourth rack 154 are referred to as first pinion 161, second pinion 162, third pinion 163, and fourth pinion 164, respectively. The first pinion 161 and the second pinion 162 have the same number of teeth and the same diameter. The third pinion 163 and the fourth pinion 164 have the same number of teeth and the same diameter, but the number of teeth and the diameter are half those of the first pinion 161 and the second pinion 162.

The second pinion 162 and the fourth pinion 164 rotate about a main rotation shaft 184, and the first pinion 161 and the third pinion 163 rotate about a driven rotation shaft 173. The main rotation shaft 184 and the driven rotation shaft 173 extend to the outside of the slider box 11 through a side surface opposite to the corresponding side of the slider box 11. A main gear 171 configured to rotate about the main rotation shaft 184 is provided at a position outside the slider box 11 in the main rotation shaft 184. A driven gear 172 configured to rotate about the driven rotation shaft 173 is provided at a position outside the slider box 11 in the driven rotation shaft 173. The main gear 171 and the driven gear 172 have the same number of teeth and are engaged with each other.

The main rotation shaft 184 is rotated by a rotation mechanism 18 described later. At this time, the driven rotation shaft 173 and the driven gear 172 rotate in opposite directions to each other at the same speed (rotation speed per unit time) as the main rotation shaft 184 and the main gear 171. Consequently, the first pinion 161 and the second pinion 162 having the same number of teeth rotate in opposite directions to each other at the same speed (the same as above), and the first rack 151 and the second rack 152 move in opposite directions to each other at the same speed (linear movement distance per unit time). In addition, the third pinion 163 and the fourth pinion 164 having the same number of teeth, the number of teeth being half the number of teeth of the first pinion 161 or the like, rotate in opposite directions to each other at the same speed as the first pinion 161 or the like, and the third rack 153 and the fourth rack 154 move in opposite directions to each other at half the speed of the first rack 151 and the like. As a result, in the chuck 14 fixed to each rack 15, the first chuck 141 and the second chuck 142 move in opposite directions to each other at the same speed as each other, and the third chuck 143 and the fourth chuck 144 move in opposite directions to each other at the same speed as each other, the speed being half the speed of the first chuck 141 or the like.

Since the main gear 171 and the driven gear 172 operate as described above, they correspond to the above-described “synchronization mechanism configured to synchronously rotate the two pinions in opposite directions to each other” described above.

The main rotation shaft 184 and the driven rotation shaft 173 are located at the same height, and the diameters of the third pinion 163 and the fourth pinion 164 are smaller than those of the first pinion 161 and the second pinion 162 as described above. Therefore, as illustrated in FIG. 6, the upper ends of the first pinion 161 and the second pinion 162 are higher than the upper ends of the third pinion 163 and the fourth pinion 164. Accordingly, the first rack 151 and the second rack 152 meshing with the pinions 16 are positioned higher than the third rack 153 and the fourth rack 154. In order to align the position of the upper surface of each slider 13 with the upper surface of the slider box 11 while coping with the difference in height, the third slider 133 and the fourth slider 134 having heights higher than the first slider 131 and the second slider 132 are used.

The rotation mechanism 18 has a first base 181, a first motor 182 provided on the first base, a first transmission mechanism 183, and the main rotation shaft 184. The first base 181 is connected to the slider box 11 by a connecting rod 196 included in the drive mechanism 19 described later. The first base 181 can advance and retreat in a direction perpendicular to the corresponding side of the sheet to be processed S, and the entire rotation mechanism 18 and the slider box 11 advance and retreat in the direction by the advance and retreat of the first base 181. The first transmission mechanism 183 is a mechanism configured to transmit the rotation of the shaft of the first motor 182 to the main rotation shaft 184, and a known mechanism can be used.

The drive mechanism 19 has a second base 191, a second motor 192, a second transmission mechanism 193, a screw shaft 194, a second base upper rail 195, and the connecting rod 196. The second transmission mechanism 193 is a mechanism configured to transmit the rotation of the shaft of the second motor 192 to the screw shaft 194. An axis of the screw shaft 194 extends in a direction perpendicular to the corresponding side of the sheet to be processed S. The second base upper rail 195 is provided on the upper surface of the second base 191 and extends in a direction perpendicular to the corresponding side. A screw member (not illustrated) that meshes with the screw of the screw shaft 194 is fixed to the first base 181, and is placed on the second base upper rail 195. As the screw shaft 194 rotates, the first base 181 advances and retreats along the second base upper rail 195 in a direction perpendicular to the corresponding side.

The slider boxes 11 included in the stretching mechanisms 10A and 10C are disposed at the same height with their longitudinal directions being parallel to each other. The slider boxes 11 included in the stretching mechanisms 10B and 10D have their longitudinal directions substantially parallel to each other and are disposed at the same height, but compared with the slider boxes 11 included in the stretching mechanisms 10A and 10C, the longitudinal directions are substantially orthogonal and are disposed at a lower position.

The slider box 11 included in each of the four stretching mechanisms 10A, 10B, 10C, and 10D, each unit provided in the slider box 11, the whole of the chuck 14, the main gear 171, the driven gear 172, and the driven rotation shaft 173, and a part of the main rotation shaft 184 and the connecting rod 196 are accommodated in one (common) thermostatic bath 20 (see FIG. 1. In FIG. 2, the thermostatic bath 20 is omitted). The side wall of the thermostatic bath 20 is provided with a hole through which the main rotation shaft 184 and the connecting rod 196 pass. A heater 21 is provided in the thermostatic bath 20. By being heated by the heater 21, the inside of the thermostatic bath 20 can be maintained at a temperature at which the sheet to be processed S is softened. An upper plate (not illustrated) of the thermostatic bath 20 is openable and closable, and when the sheet to be processed S is attached to the chuck 14 or when the sheet to be processed S after the stretching treatment is removed from the chuck 14, the upper plate is opened to perform an operation.

The biaxial stretching apparatus 1 further includes a control unit 25 configured to control the rotation of the first motor 182 and the second motor 192 of each stretching mechanism 10 and the output of the heater 21. Regarding the rotation of the first motor 182 and the second motor 192, for example, focusing on the stretching mechanism 10A, the rotation speed of the first motor 182 of the stretching mechanism 10A and the rotation speed of the second motor 192 of the stretching mechanisms 10B and 10D are controlled such that each chuck of the stretching mechanism 10A moves at a speed synchronized with the speed at which the corresponding side of the stretching mechanism 10A of the sheet to be processed S is stretched along with the rotation of the second motor 192 of the stretching mechanisms 10B and 10D adjacent to both sides of the stretching mechanism 10A. For each of the stretching mechanisms 10B to 10D, the rotation speed of the first motor 182 of the stretching mechanism and the rotation speed of the second motor 192 of the stretching mechanism adjacent on both sides are controlled by the same method. The first motor 182, the second motor 192, and the control unit 25 correspond to the above-described “synchronous expansion mechanism configured to rotate two pinions of the present stretching mechanism in synchronization with movement of the drive mechanisms of the stretching mechanisms corresponding to two adjacent sides of the sheet to be processed”.

A method of using the biaxial stretching apparatus 1 of the first embodiment will be described. In the initial state, by rotating the first motor 182, each chuck 14 is disposed such that the adjacent chucks 14 are closest to each other as illustrated in FIGS. 1 and 7. In this state, the upper plate of the thermostatic bath 20 is opened, and the four sides of the rectangular sheet to be processed S are gripped by the chucks 14. Thereafter, the upper plate of the thermostatic bath 20 is closed.

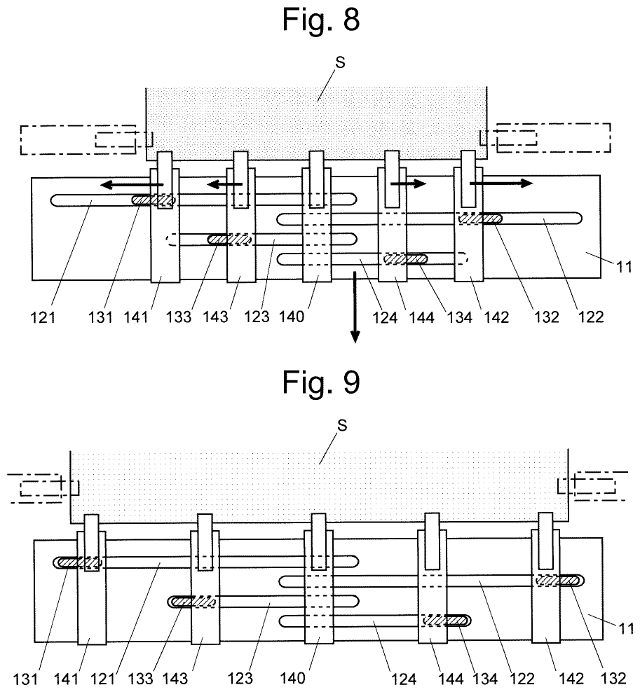

The control unit 25 performs temperature control so that the inside of the thermostatic bath 20 is within a predetermined temperature range in which the sheet to be processed S is softened by applying an electric current to the heater 21 and adjusting the magnitude of the electric current. After the inside of the thermostatic bath 20 falls within this temperature range, the control unit 25 rotates the second motor 192 of each stretching mechanism 10 to move the slider box 11 toward the side opposite to the corresponding side of the sheet to be processed S (vertical arrow in FIG. 8). At the same time, the control unit 25 rotates the first motor 182 of each stretching mechanism 10. By the rotation of the first motor 182, as described above, the first chuck 141 and the second chuck 142 move in opposite directions to each other (arrows in the horizontal directions in FIG. 8) at the same speed as each other, and the third chuck 143 and the fourth chuck 144 move in opposite directions to each other (same) at the same speed as each other, the speed being half the speed of the first chuck 141 or the like. Note that the 0th chuck 140 does not move. Here, in each stretching mechanism 10, the control unit 25 controls the rotation speed of the first motor 182 and the rotation speed of the second motor 192 of each stretching mechanism 10 so that the movement of each chuck 14 is synchronized with the speed at which the corresponding side of the sheet to be processed S is stretched by the stretching mechanisms 10 adjacent on both sides of the corresponding side.

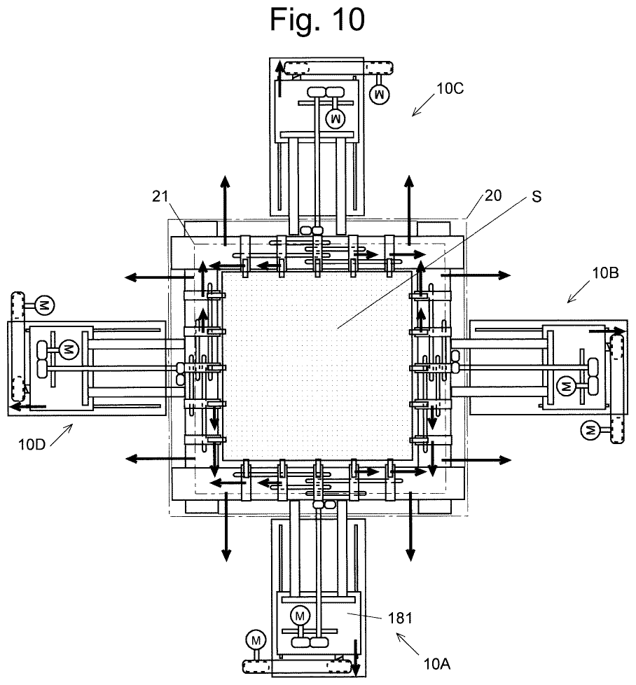

By the above operation, the sheet to be processed S is stretched in four directions. FIG. 8 illustrates a state in which the sheet to be processed S is stretched to about half of the most stretched state, and FIGS. 9 and 10 illustrate a state in which the sheet to be processed S is stretched the most. The extent to which the sheet to be processed S is stretched (distance to which the slider box 11 is moved) is arbitrary.

After the stretching of the sheet to be processed S is completed, the heater 21 is stopped to open the upper plate of the thermostatic bath 20, and the sheet to be processed S is taken out.

According to the biaxial stretching apparatus 1 according to the first embodiment, since the rail 12, which is a component for adjusting the interval between the chucks 14, is provided in parallel to the corresponding side of the sheet to be processed S, the space occupied by the apparatus in the direction perpendicular to the corresponding side can be suppressed, whereby the entire apparatus can be downsized.

As the entire apparatus can be downsized in this manner, the volume of the thermostatic bath 20 can also be downsized, so that the power consumption of the heater 21 can also be suppressed.

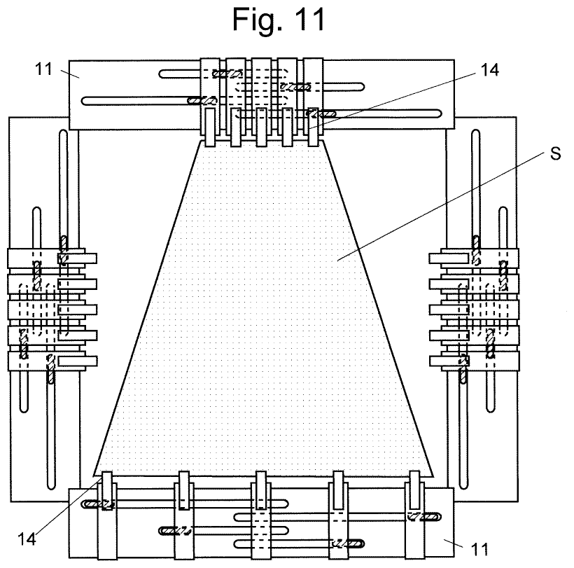

In the example illustrated so far, the four sides of the sheet to be processed S are equally expanded, but the expansion degree may be changed instead of being equal in the two opposing sides. For example, the operation may be performed such that only two opposing sides of the four sides of the sheet to be processed S are held by the chucks 14 of only two (for example, the stretching mechanisms 10A and 10C) of the four stretching mechanisms 10, and then the slider box 11 is moved in a direction perpendicular to the corresponding side of the sheet to be processed S in one or both of the two stretching mechanisms 10, and the chuck 14 is moved only in one of the stretching mechanisms 10. In these cases, the chuck 14 of the stretching mechanism 10 to which the slider box 11 moves does not need to be synchronized with the slider boxes 11 (in the previous example, all the stretching mechanisms 10 move at the same time, but in this example, they do not move) of the remaining two stretching mechanisms 10, and thus can be moved independently of the slider box 11. That is, the slider box 11 and the chuck 14 may be moved at the same time, or only one of them may be moved first. In either case, as illustrated in FIG. 11, the sheet to be processed S is finally stretched in a trapezoidal shape.

### (2) An Embodiment (Second Embodiment) of a Biaxial Stretching Apparatus According to the Second Mode of the Present Invention

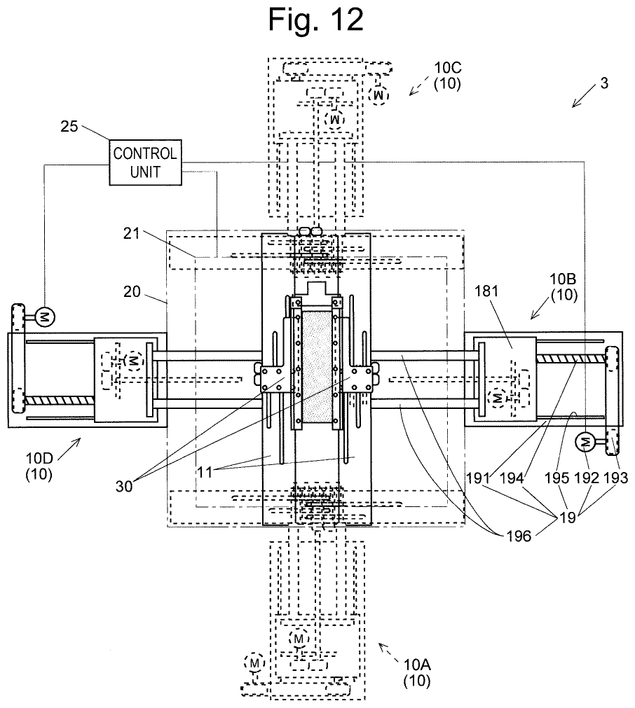

As illustrated in FIG. 12, a stretching apparatus 3 of the second embodiment is obtained by adding an additional mechanism 30 as an option to the biaxial stretching apparatus 1 of the first embodiment. The additional mechanism 30 is detachably attached to the upper surface of the slider box 11 of each of the two opposing stretching mechanisms 10B and 10D among the four stretching mechanisms 10A to 10D of the biaxial stretching apparatus 1. In addition, since the slider boxes 11 of the two stretching mechanisms 10A and 10C to which the additional mechanism 30 is not attached are not used in the stretching apparatus 3 of the second embodiment, the slider boxes 11 are retracted by operating the drive mechanisms 19 provided in the two stretching mechanisms 10A and 10C as indicated by broken lines in FIG. 12. Note that the chucks 14 provided in the biaxial stretching apparatus 1 are removed from the slider boxes 11 of the stretching mechanisms 10B and 10D to which the additional mechanism 30 is attached (the chucks 14 of the slider box 11 of the stretching mechanisms 10A and 10C which are not used may remain attached).

As illustrated in an enlarged view in FIG. 13, the additional mechanism 30 has two gripping members 31, two first gripping member holding parts 32, and two second gripping member holding parts 33.

The gripping member 31 is a rod-shaped member having a rectangular shape in top view, and is provided with a clip 311 for gripping the long side of the rectangular sheet to be processed S over a linear range on one side of the long side of the rectangle. The two gripping members 31 are disposed such that the clips 311 face each other. The bottom surface of the gripping member 31 is provided with a groove 312 extending in the longitudinal direction.

In the present embodiment, the two first gripping member holding parts 32 are members fixed to the surface of one (common) plate-shaped member 320 so as to stand apart from each other, and are inserted into holes provided at respective one ends of the two gripping members 31 (in this example, ends on the side of the stretching mechanism 10C). Consequently, each of the two first gripping member holding parts 32 rotatably holds the gripping member 31 into which the first gripping member holding part 32 is inserted.

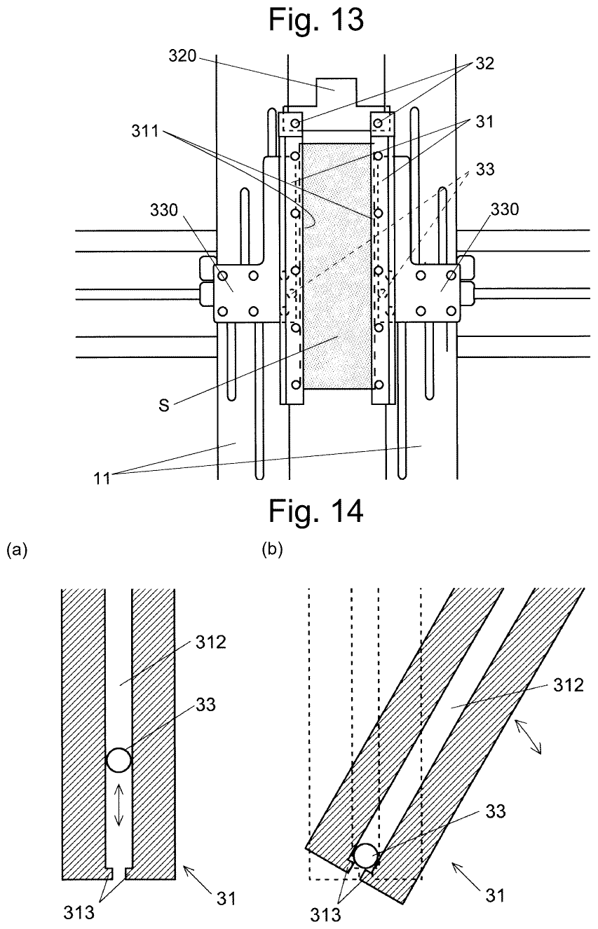

Each of the two second gripping member holding parts 33 is a member fixed so as to stand on the upper surface of the plate-shaped fixture 330 fixed to the upper surface of each of the two opposing slider boxes 11 with a screw, and has a cam follower configured to rotate about an axis perpendicular to the upper surface of the fixture 330 at the distal end of the member. These two second gripping member holding parts 33 are inserted into the respective grooves 312 provided in the two gripping members 31. At the other end of the gripping member 31 (in this example, the end on the stretching mechanism 10A side), a stopper 313 which prevents detachment of a second rotary shaft 332 is provided in the groove 312. With these configurations, the second gripping member holding part 33 can slide relative to the groove 312 of the gripping member 31, and can rotate the gripping member 31 in a state of sliding until abutting on the stopper 313 (FIG. 14(b)). At that time, since the second gripping member holding part 33 has the cam follower, the gripping member 31 can be smoothly rotated. Note that as the second gripping member holding part 33, a part including a pin may be used instead of a part having a cam follower.

The control unit 25 controls the operation of the second motor 192 of the stretching mechanisms 10B and 10D and the output of the heater 21. It is unnecessary to control the second motors 192 of the stretching mechanisms 10A and 10C, which are not used in the stretching apparatus 3 of the second embodiment, and the first motor 182 of each stretching mechanism 10.

The operation of the stretching apparatus 3 of the second embodiment will be described. First, by operating the drive mechanisms 19 provided in the stretching mechanisms 10B and 10D, the control unit 25 causes the two gripping members 31 to approach each other to a distance slightly shorter than the lengths of the two sides that are not gripped by the gripping members 31 among the four sides of the sheet to be processed S. Subsequently, the two gripping members 31 are slid to appropriate positions in the longitudinal direction (where the user can easily perform the operation). Moreover, the user causes the clips 311 of the gripping members 31 different from each other to grip two of the four sides of the sheet to be processed S.

Next, the control unit 25 performs temperature control by applying an electric current to the heater 21 and adjusting the magnitude of the electric current so that the inside of the thermostatic bath 20 is within a predetermined temperature range in which the sheet to be processed S is softened. After the inside of the thermostatic bath 20 falls within this temperature range, the control unit 25 causes the two slider boxes 11 to move in opposite directions to each other (directions perpendicular to two sides of the sheet to be processed S held by the gripping member 31) by rotating the second motor 192 of the stretching mechanisms 10B and 10D. Then, the two gripping members 31 are pushed by the second gripping member holding part 33 fixed to the slider box 11 via the fixture 330 and move in opposite directions to each other. Consequently, the two gripping members 31 rotate in opposite directions to each other about the first gripping member holding part 32, and slide while being guided by the groove 312 until the second gripping member holding part 33 abuts on the stopper 313. When the second gripping member holding part 33 abuts on the stopper 313, the two gripping members 31 further rotate in opposite directions to each other about the second gripping member holding part 33.

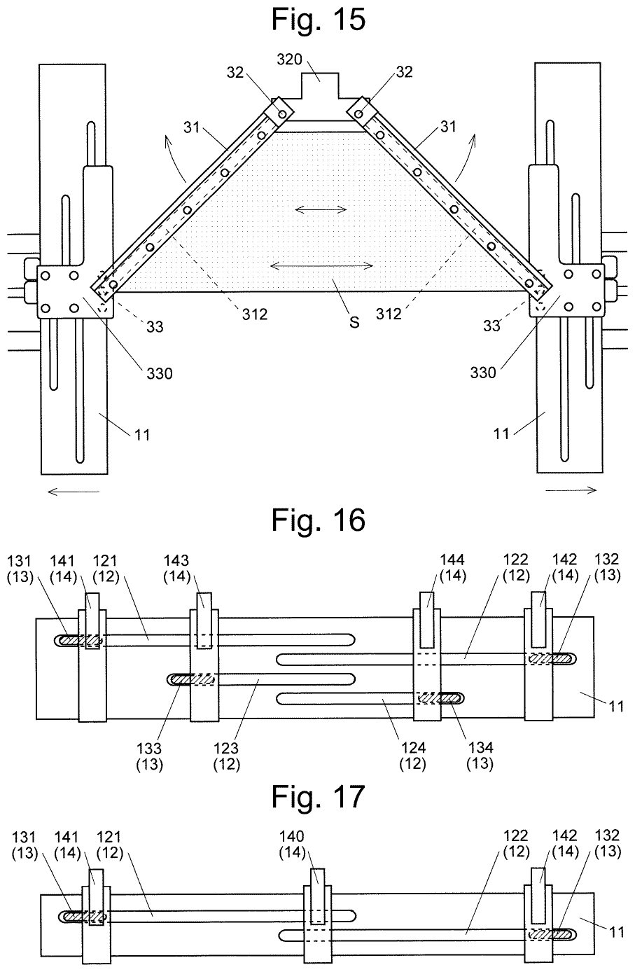

As a result of the above operation, as illustrated in FIG. 15, the two gripping members 31 move so that the interval between the one ends does not change and the interval between the other ends is increased, and are disposed in an inverted V shape. By this movement of the gripping member 31, the sheet to be processed S as a whole is stretched in a direction perpendicular to the two sides gripped by the gripping member 31, but is ununiformly stretched such that the stretching ratio is the largest near the other end and is substantially 1 (substantially not stretched) near the one end. The shape of the sheet to be processed S after stretching is a trapezoid.

According to the stretching apparatus 3 of the second embodiment, it is possible to obtain a sheet in which a transient state is reproduced in a mass production apparatus of sheets including a uniaxial stretching apparatus or a sequential biaxial stretching apparatus using two rails provided so that the interval gradually increases in some sections. By examining the state of the polymer or the like in the sheet thus obtained, it is possible to confirm a phenomenon occurring in the sheet in a mass production machine.

### (3) Modifications

The present invention is not limited to the above embodiments, and various variations are possible.

For example, in the biaxial stretching apparatus 1 of the first embodiment, the 0th chuck 140 may be omitted as illustrated in FIG. 16.

In addition, in the biaxial stretching apparatus 1 of the first embodiment, the third chuck 143 and the fourth chuck 144 may be omitted as illustrated in FIG. 17. In this case, the third rail 123, the fourth rail 124, the third slider 133, the fourth slider 134, the third rack 153, the fourth rack 154, the third pinion 163, and the fourth pinion 164 are unnecessary. Alternatively, in the configuration illustrated in FIG. 17, the 0th chuck 140 may be further omitted.

FIGS. 16 and 17 illustrate an example in which the number of chucks 14 is reduced as compared with that in the above embodiment, but conversely, the number of chucks 14 may be increased as compared with that in the first embodiment. In this case, the rail 12, the slider 13, the rack 15, and the pinion 16 are also increased by the same number. Then, the number of teeth of each pinion 16 is set such that each chuck 14 moves in synchronization with the speed of stretching of the corresponding side by the stretching mechanism 10 adjacent to the corresponding side of the sheet to be processed. For example, by adding two chucks to both outer sides of the five chucks (the 0th chuck 140 to the fourth chuck 144) described in the above embodiment, adding two rails, sliders, racks, and pinions corresponding to the two chucks, and making the number of teeth of the two pinions 3/2 times that of the first pinion 161, a configuration including a total of seven chucks per one slider box can be adopted. The same applies to a case where the number of chucks is further increased (to 9, 11, . . . , etc.) or a case where the 0th chuck 140 is omitted (total number is 6, 8, 10 . . . , etc.).

If the frictional resistance to the slider 13 generated at the time of moving the rail 12 is sufficiently reduced, it is possible to move each chuck 14 in synchronization with the speed of extension of the corresponding side by the stretching mechanism 10 adjacent to the corresponding side of the sheet to be processed without using the rack 15, the pinion 16, and the like. In this case, in the biaxial stretching apparatus 1 of the first embodiment, the rack 15, the pinion 16, and the rotation mechanism 18 may be omitted.

The stretching apparatus 3 of the second embodiment is obtained by adding the additional mechanism 30 as an option to the biaxial stretching apparatus 1 of the first embodiment. However, as an apparatus different from the biaxial stretching apparatus 1 of the first embodiment, an apparatus in which a gripping member 31, a first gripping member holding part 32, and a second gripping member holding part 33 are disposed in each of the two drive mechanisms, and the gripping members 31 are disposed to face each other may be used.

In the stretching apparatus 3 of the second embodiment, since the two first gripping member holding parts 32 are fixed to one (common) plate-shaped member 320, the sheet to be processed S does not move in the pulling direction when being pulled, and thus the sheet to be processed S is hardly stretched near the one end of the gripping member 31. On the other hand, when the sheet to be processed S is desired to be unevenly stretched at different stretching ratios near one end and near the other end while being stretched also near one end of the gripping member, the two second gripping member holding parts may be pulled and the two first gripping member holding parts may be pulled at a pulling speed different from that of the second gripping member holding part by the drive mechanism without fixing the two first gripping member holding parts to each other. As described above, since the first gripping member holding part and the second gripping member holding part have different pulling speeds, the sheet to be processed is unevenly stretched at different stretching ratios near one end and near the other end of the gripping member. At this time, the stretching ratio near the one end can be adjusted by the pulling speed of the first gripping member holding part.

### REFERENCE SIGNS LIST

1 . . . Biaxial Stretching Apparatus
10, 10A, 10B, 10C, 10D . . . Stretching Mechanism
11 . . . Slider Box
12 . . . Rail
121 . . . First Rail
122 . . . Second Rail
123 . . . Third Rail
124 . . . Fourth Rail
13 . . . Slider
131 . . . First Slider
132 . . . Second Slider
133 . . . Third Slider
134 . . . Fourth Slider
14 . . . Chuck
140 . . . 0th Chuck
141 . . . First Chuck
142 . . . Second Chuck
143 . . . Third Chuck
144 . . . Fourth Chuck
1491 . . . Base Portion
1492 . . . Gripping Portion
15 . . . Rack
151 . . . First Rack
152 . . . Second Rack
153 . . . Third Rack
154 . . . Fourth Rack
16 . . . Pinion
161 . . . First Pinion
162 . . . Second Pinion
163 . . . Third Pinion
164 . . . Fourth Pinion
171 . . . Main Gear
172 . . . Driven Gear
173 . . . Driven Rotation Shaft
18 . . . Rotation Mechanism
181 . . . First Base
182 . . . First Motor
183 . . . First Transmission Mechanism
184 . . . Main Rotation Shaft
19 . . . Drive Mechanism
191 . . . Second Base
192 . . . Second Motor
193 . . . Second Transmission Mechanism
194 . . . Screw Shaft
195 . . . Second Base Upper Rail
196 . . . Connecting Rod
20 . . . Thermostatic Bath
21 . . . Heater
25 . . . Control Unit
3 . . . Stretching Apparatus
30 . . . Additional Mechanism
31 . . . Gripping Member
311 . . . Clip
312 . . . Groove
313 . . . Stopper
32 . . . First Gripping Member
320 . . . Fixture of First Gripping Member
33 . . . Second Gripping Member Holding Part
330 . . . Fixture of Second Gripping Member Holding Part
S . . . Sheet to Be Processed

1. A biaxial stretching apparatus, in which each of stretching mechanisms provided respectively on four sides of a sheet to be processed includes:
a) a slider box including a rail provided in parallel to a corresponding side of the stretching mechanism and two sliders configured to slide on the rail;
b) chucks respectively provided in the two sliders configured to grip the corresponding side of the sheet to be processed; and
c) a drive mechanism configured to pull the slider box in a direction perpendicular to the corresponding side.

2. The biaxial stretching apparatus according to claim 1, further comprising:
d) racks having the same pitch respectively fixed to the two sliders;
e) pinions having the same number of teeth which respectively mesh with the two racks; and
f) a synchronization mechanism configured to synchronously rotate the two pinions in opposite directions to each other.

3. The biaxial stretching apparatus according to claim 2, further comprising
g) a synchronous expansion mechanism configured to rotate two pinions of the present stretching mechanism in synchronization with movement of the drive mechanisms of the stretching mechanisms corresponding to two adjacent sides of the sheet to be processed.

4. The biaxial stretching apparatus according to claim 2, wherein
rails for sliding two additional rack-attached sliders are provided in the slider box,
an additional chuck for gripping the corresponding side of the sheet to be processed and an additional pinion are provided together respectively in the two additional rack-attached sliders, and
the additional racks and the additional pinions of the two additional rack-attached sliders are set so as to move in opposite directions to each other at a speed corresponding to gripping positions of the two chucks and the two additional chucks on the corresponding side.

5. A stretching apparatus, comprising:
two rod-shaped gripping members configured to grip two opposing sides of a rectangular sheet to be processed along the respective sides;
two first gripping member holding parts configured to rotatably hold respective one ends of the two gripping members; and
two second gripping member holding parts configured to rotatably hold the respective other ends of the two gripping members; and
a drive mechanism configured to pull the two first gripping member holding parts and the two second gripping member holding parts at different speeds from each other in a direction perpendicular to the two sides.

6. The stretching apparatus according to claim 5, wherein the speed at which the drive mechanism pulls the two first gripping member holding parts is zero.

7. The biaxial stretching apparatus according to claim 3, wherein
rails for sliding two additional rack-attached sliders are provided in the slider box,
an additional chuck for gripping the corresponding side of the sheet to be processed and an additional pinion are provided together respectively in the two additional rack-attached sliders, and
the additional racks and the additional pinions of the two additional rack-attached sliders are set so as to move in opposite directions to each other at a speed corresponding to gripping positions of the two chucks and the two additional chucks on the corresponding side.
